(19) United States
(12) Patent Application Publication
(10) Pub. No.: US 2026/0338266 A1
(43) Pub. Date: Oct. 29, 2026

(54) HYDROSTATIC TRANSMISSION

(71) Applicant: AGCO International GmbH, Neuhausen Am Rheinfall (CH)

(72) Inventors: Richard HEINDL, Marktoberdorf (DE); Steffen WALTER, Marktoberdorf (DE)

(21) Appl. No.: 19/487,918

(22) PCT Filed: Apr. 18, 2024
(86) PCT No.: PCT/IB2024/053794

§ 371 Date: Nov. 25, 2025

(30) Foreign Application Priority Data
May 26, 2023 (GB) 2307892.6

(51) Int. Cl. F16H 47/04; B60K 17/28; B60K 17/344; B60K 17/356; F16H 39/06; F16H 57/00; F16H 61/42; F16H 61/448

(52) U.S. Cl. CPC F16H 47/04; B60K 17/344; B60K 17/356; F16H 39/06; F16H 61/42; F16H 61/448; B60K 17/28; F16H 2047/045; F16H 2057/0012

(57) ABSTRACT

Hydrostatic Transmission A hydrostatic transmission (120) has a first hydrostatic device (140) fluidly coupled with a second hydrostatic device (142) and a third hydrostatic device (142a). The first hydrostatic device is a variable displacement bent axis hydrostatic device having a first pivot housing (216) rotatable about a first pivot housing axis (218) to vary the displacement of the first hydrostatic device. Each of the second and the third hydrostatic devices is a variable displacement bent axis device, the second and third hydrostatic devices having a combined second pivot housing (240) rotatable about a second pivot housing axis (242) to simultaneously vary the displacements of the second and third hydrostatic devices. The hydrostatic transmission is configured such that the second and third hydrostatic devices operate at different speeds and may form part of a power split CVT in a utility vehicle.

### CROSS-REFERENCE TO RELATED APPLICATIONS

Not applicable.

### FIELD

Embodiments of the present disclosure relate generally to a hydrostatic transmission.

### BACKGROUND

A vehicle powertrain typically comprises a prime mover (e.g., a source of motive power such as an internal combustion engine, an electric motor, a fuel-cell, or a hybrid combination of any of these, for example) a transmission, and a drivetrain. The prime mover generates a torque output which is transferred to the transmission, whose primary purpose is to is to enable the torque to be transmitted to driven ground engaging members, such as wheels or tracks, with a variable speed ratio so that the vehicle can be moved across the ground in a controlled manner. The drivetrain transfers the torque output from the transmission to driven ground engaging members and may include one or more clutches; a transfer box; and at least one of a front, centre, or rear axle final drive/differential. Many different powertrain configurations are known which can be adapted to the needs of a specific type of vehicle, for example whether the vehicle is rear axle drive, front axle drive, twin axle drive (e.g., four-wheel drive), front wheel steered, centrally articulated, or track steered. The transmission may also provide drive to a front and/or a rear power take off (PTO) shaft to allow the vehicle to operate ancillary equipment, e.g., for driving agricultural implements in the case of a tractor.

Utility vehicles with infinitely or continuous variable transmissions (CVT) are well known, and modern examples often employ a power split CVT in which power is divided between a hydrostatic branch with a continuously variable ratio and a mechanical branch with a fixed ratio, the power being recombined at, or upstream of, one or more output shafts. Power split CVTs are used in a wide variety of utility vehicle types, including construction vehicles, plant machinery, and agricultural vehicles such as agricultural tractors and self-propelled mobile agricultural machines. Power split CVTs enable, to an extent at least, the vehicle speed (i.e., the speed of the vehicle across the ground) to be adjusted independently of the rotary speed of the prime mover so that the prime mover can be operated at an efficient rotary speed regardless of the vehicle speed. Examples of or these types of transmission are described in European Patent Publication EP1273828 A2, published 8 Jan. 2003, by AGCO GmbH & Co. and German Patent Publication DE 10 2007 021 733 A1, published 13 Nov. 2008, by AGCO GmbH.

Known hydrostatic transmissions have at least two hydrostatic devices in the form of hydraulic piston machines connected by fluid lines. A first device operates as a pump and a second device operates as a motor. In many known systems, each of the hydrostatic devices has a variable displacement and may be of bent axis or swash plate design. By varying the displacement of at least the first device acting as a pump, a continuously variable ratio from zero to a maximum value is obtained to provide a continuously variable transmission. To reverse the torque direction, the second hydrostatic device is operated as a pump and the first as a motor.

The amount of torque that can be transmitted depends on the displacement of the hydrostatic devices, with larger displacement devices required to transmit a greater amount of torque. Recently, hydrostatic transmissions using three hydrostatic devices have been developed in which a first hydrostatic device is fluidly connected with both a second and a third hydrostatic device. For forward motion, the first hydrostatic device is operated as a pump and the second and third hydrostatic devices are operated as motors, the mechanical outputs of which are combined. The use of two hydrostatic devices operating synchronously as motors enables smaller displacement devices to be used to transmit a given amount of torque. This can be beneficial as smaller hydrostatic devices can be operated a greater speed than larger devices with a greater mass. Furthermore, the use of smaller displacement hydrostatic devices tends to reduce the amplitude of pressure pulsations in the fluid.

### BRIEF SUMMARY

Aspects of the disclosure relate to a hydrostatic transmission, a hydraulic-mechanical power-split transmission, and to a utility vehicle.

In an aspect of the disclosure, there is provided a hydrostatic transmission including a first hydrostatic device fluidly coupled with both a second hydrostatic device and a third hydrostatic device, the first hydrostatic device comprising a variable displacement bent axis hydrostatic device having a first pivot housing rotatable about a first pivot housing axis to vary the displacement of the first hydrostatic device, each of the second and the third hydrostatic devices comprising a variable displacement bent axis device, the second and third hydrostatic devices having a combined second pivot housing rotatable about a second pivot housing axis to simultaneously vary the displacements of the second and third hydrostatic devices, wherein the first and second pivot housing axes are aligned parallel to and offset from one another, drive shafts of the second and third hydrostatic devices are drivingly coupled to a common shaft and the second and third hydrostatic devices are constrained to operate at different speeds.

By arranging for the first and second pivot housings to rotate about parallel axes, the hydrostatic transmission can be configured in a compact arrangement and operating the second and third hydrostatic devices operate at different speeds can help to reduce noise.

The second and third hydrostatic devices may be constrained to operate at speeds that differ in the range of 2% to 15%, or in the range of 5% to 10%.

The first and second pivot housings may be arranged side-by-side. The first pivot housing may overlap the second pivot housing over at least part of the length of the second pivot housing as measured in a direction parallel to the second pivot housing axis. Substantially the whole of the length of the first pivot housing as measured in a direction parallel to the first pivot housing axis may overlap the second pivot housing.

The first and second pivot housing axes may each be aligned generally vertically.

Each of the first, second and third hydrostatic devices may comprise a hydraulic piston machine having a cylinder block defining a plurality of cylinders and ports, pistons within the cylinders of the cylinder block and a drive shaft.

The drive shafts of the second and third hydrostatic devices may be drivingly coupled to the common shaft by a gear train or equivalent structure such as a gear chain drive. The gear train may be configured to provide different gear rations between the common shaft and each of the second and third hydrostatic devices.

The first and second pivot housings may be rotatably supported on a hydrostatic transmission module housing. The hydrostatic transmission module housing may include a bridge housing supporting the first and second pivot housings at one end. The first and second pivot housings and the bridge housing may each define at least one fluid passage, the at least one fluid passage in each of the first and second pivot housings being fluidly connected with the at least one fluid passage in the bridge housing through a respective rotary joint. The at least one fluid passage in the first pivot housing may be fluidly connected with ports of a cylinder block of the first hydrostatic device. The at least one fluid passage in the second pivot housing may be fluidly connected with ports of a respective cylinder block of each of the second and third hydrostatic devices. The bridge housing may support the first and second pivot housings from below. The hydrostatic transmission module housing may comprise an upper housing for rotatably supporting upper end regions of first and second pivot housings from above.

The hydrostatic transmission may comprise a first actuator for controlling rotation of the first pivot housing about the first pivot housing axis to vary the displacement of the first hydrostatic device.

The hydrostatic transmission may comprise a second actuator for controlling rotation of the second pivot housing about the second pivot housing axis to vary the displacement of the second and third hydrostatic devices.

The hydrostatic transmission may be configured such that, in use, the first hydrostatic device operates as a pump and the second and third hydrostatic devices act as motors when operating in a forward drive mode of operation.

In an aspect of the disclosure, there is provided a power split CVT having a mechanical branch and a hydrostatic branch comprising a hydrostatic transmission according to the previous aspect of the disclosure as set out above, the mechanical drive outputs from the second and third hydrostatic devices being coupled together to a summing shaft.

In another aspect of the disclosure, there is provided a utility vehicle having a hydrostatic transmission according to the aspect of the disclosure first set out above.

The hydrostatic transmission may be part of a power split CVT including a mechanical branch having a fixed ratio, the hydrostatic transmission forming a hydrostatic branch of the power split CVT with a variable ratio. The hydrostatic transmission may be configured such that, in use, the first hydrostatic device operates as a pump and the second and third hydrostatic devices operate as motors when operating in a forward drive mode of the vehicle.

In a still further aspect of the disclosure, there is provided a power split CVT having a mechanical branch and a hydrostatic branch, wherein the hydrostatic branch comprises a first hydrostatic device fluidly coupled with both a second hydrostatic device and a third hydrostatic device, the first hydrostatic device comprising a variable displacement bent axis hydrostatic device having a first pivot housing rotatable about a first pivot housing axis to vary the displacement of the first hydrostatic device, each of the second and the third hydrostatic devices comprising a variable displacement bent axis device, the second and third hydrostatic devices having a combined second pivot housing rotatable about a second pivot housing axis to simultaneously vary the displacements of the second and third hydrostatic devices, wherein the first and second pivot housing axes are aligned parallel to and offset from one another.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIG. 1 is a representation of an agricultural/utility vehicle, in the form of a tractor which may be provided with a powertrain having a hydrostatic transmission;

FIG. 2 is a schematic representation of an embodiment of a vehicle powertrain configuration incorporating a hydrostatic transmission suitable for use in the vehicle of FIG. 1;

FIG. 3 is view of part of an embodiment of a hydrostatic transmission module forming part of a hydrostatic transmission and which may be incorporated into the powertrain of FIG. 2, the view taken from one side of the module;

FIG. 4 is a view similar to that of FIG. 3 but taken from the opposite side of the hydrostatic transmission module; and

FIG. 5 is a perspective view of the hydrostatic transmission module of FIGS. 3 and 4 with an upper housing omitted to show internal details.

### DETAILED DESCRIPTION

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

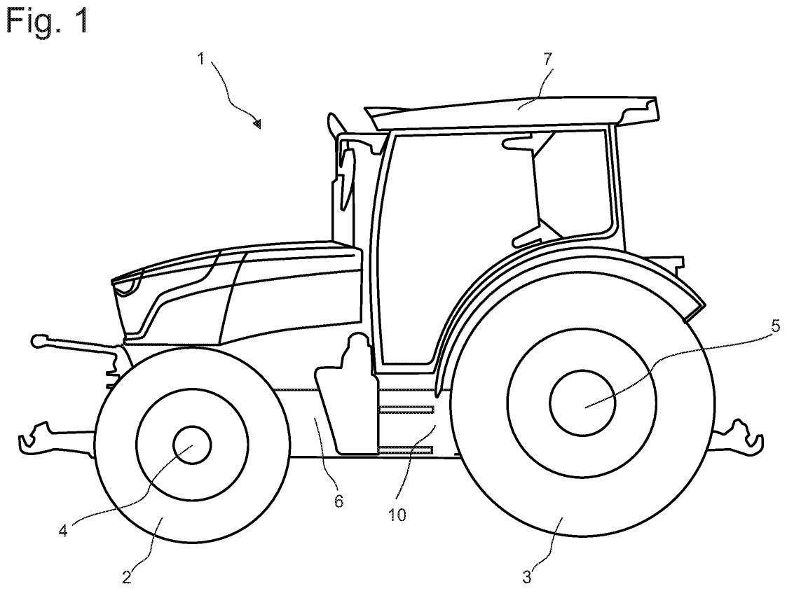

An embodiment of a hydrostatic transmission according to an aspect of the disclosure will be described below with reference to a transmission for use in an agricultural tractor 1, such as that illustrated in FIG. 1. However, it should be understood that hydrostatic transmissions in accordance with the disclosure as described herein are not limited to use in agricultural tractors but can be adapted for use in a range of other types of vehicle, including (without limitation): trucks and lorries as well as utility vehicles including construction vehicles and plant machinery, such as excavators and the like, and agricultural vehicles other than tractors. The term vehicle should be understood as encompassing self-propelled mobile machines such as combine harvesters, sprayers and the like.

FIG. 1 illustrates an agricultural tractor 1 (hereinafter referred to simply as a tractor) provided with front and rear wheels 2, 3 mounted to front and rear axles 4, 5 which are connected to a chassis 6. The tractor 1 has an operator cab 7 supported on the chassis and/or the rear axle 5.

Whilst the tractor 1 is illustrated with front and rear wheels 2, 3, the present disclosure can be adapted for use with vehicles having tracks, a combination of wheels or tracks, and/or other types of ground engaging members to support the vehicle for movement over the ground.

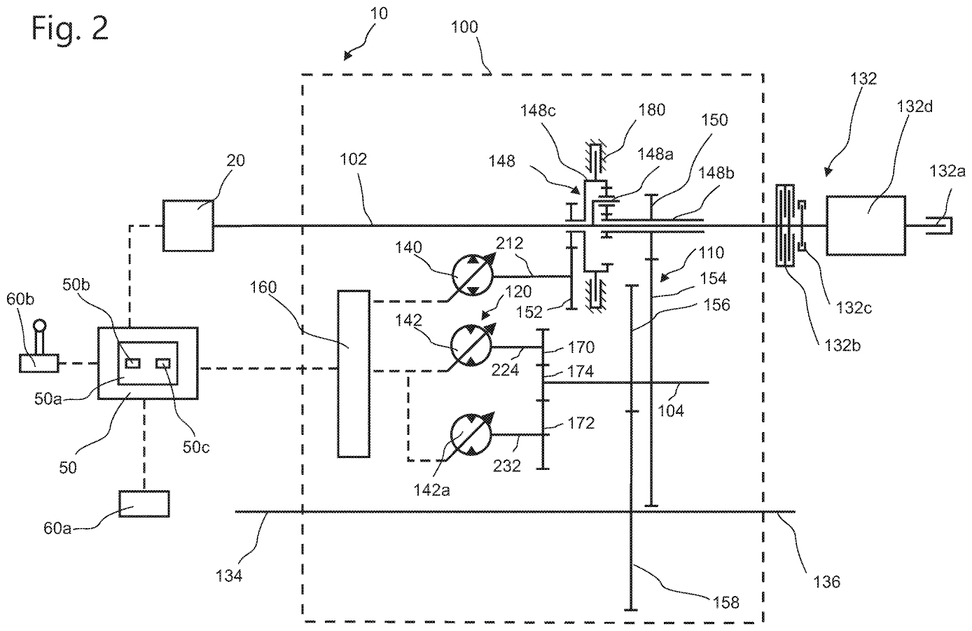

The tractor 1 has a powertrain 10 as illustrated schematically in FIG. 2. The powertrain includes a prime mover (alternatively referred to as a source of motive power) 20 and a transmission 100 for forwarding power/torque with a variable speed ratio from the prime mover 20 to the axles 4, 5 and hence to the front and rear wheels 2, 3 or other driven ground engaging members as may be the case.

The prime mover 20 can be any suitable source of motive power for the vehicle 1 and may be an internal combustion engine such as a diesel engine or an electric prime mover such as an AC electric motor, a fuel-cell or a combination of any of these.

Motive power from the prime mover 20 is forwarded to the front and rear axles 4, 5 via the transmission 100. An electronic control system 50 includes at least one controller 50a (which may be part of an ECU) and input/output (I/O) interface(s) which may include a touch screen display or monitor 60a. The control system 50 is operative to control, amongst other things, the prime mover 20 and the transmission 100 to meet requirements including a demanded vehicle speed. The demanded vehicle speed may be input via a driver input device (illustrated schematically at 60b) which is electronically connected to the control system 50. The driver input device 60b may comprise a foot pedal or a hand control (e.g., a joystick) manually operated by a driver and which provides an input signal to the control system 50 indicative of a demanded vehicle speed. A driver may input a demand for a vehicle speed in other ways. For example, the control system 50 may be configured to enable the driver to select or input a demanded vehicle speed using other input devices such as buttons or via icons on the touch screen monitor 60a or voice control. The control system 50 may be configured such that a driver is able to select various operational modes for the vehicle which may include instructions for predetermined demanded vehicle speeds. Alternatively, the control system 50 may generate a demanded vehicle speed requirement if the vehicle is operated in a fully or partly autonomous mode or a demanded vehicle speed input may be provided remotely by means of a suitable interface (wired or wireless) if the vehicle is remotely controlled, say as part of a leader-follower vehicle configuration.

Drive is transmitted from the prime mover 20 to the transmission 100 though a transmission input shaft 102 (which is drivingly coupled to, or may be an extension of, an output shaft of the prime mover) and is output from the transmission through front and rear output drive shafts 134, 136, which in this embodiment provide propulsive drive to the front and rear axles 4, 5 to drive the front and rear wheels 2, 3. Alternatively, at least one of the front and/or rear output drive shafts 134, 136 may provide propulsive drive to tracks. In alternative embodiments, the transmission may have only one output drive shaft to provide drive to a single axle or may comprise output drive shafts which extend laterally to drive ground engaging members on opposite sides of the vehicle.

In addition to providing tractive drive for the vehicle, the powertrain also has an auxiliary drive system 132 referred to as a power take-off (PTO) system. The PTO system 132 has a PTO shaft 132a (PTO output or stub shaft) which can be drivingly coupled with an input drive shaft on an implement attached to the tractor or other ancillary equipment to provide drive to the implement or ancillary equipment. The PTO shaft 132a is driven drivingly connectable to the prime mover 20, in this case through the transmission input shaft 102, by a PTO clutch 132b. The PTO clutch 132b may be of any suitable type and may be a friction clutch or a positive engagement clutch, such as a dog clutch. The PTO clutch 132b may be fluid or electronically actuated. When the PTO clutch 132b is engaged, drive is transmitted from the prime mover via the input shaft 102 to the PTO shaft 132a. When the PTO clutch 132b is disengaged, drive is not transmitted from the prime mover 20 to the PTO shaft 132a. The PTO clutch 132b may actuatable under control of the control system 50. A PTO brake 132c may also be provided to enable the PTO shaft 132a and any attached implement to be braked. Where provided, the PTO brake 132c may be of any suitable type and may be a friction or positive engagement brake which may be fluid actuated, for example. Where provided, the PTO brake 132c may actuatable under control of the control system 50. The PTO system 132 may also include a PTO transmission 132d. In an embodiment the PTO transmission 132d provides a fixed drive ratio between the prime mover 20 and the PTO shaft 132a. The PTO transmission 132d can be provided at any suitable position in the drive line between the prime mover 20 and the PTO shaft 132a or may be omitted if no speed reduction is required between the prime mover and the PTO shaft 132a.

It will be appreciated that drive from the prime mover 20 to the transmission 100 and the PTO system 132 can be split in many different ways and that drive to the PTO clutch need not be routed through an input shaft 102 to the transmission 100.

The transmission 100 is a power split CVT drive in which drive (power/torque) is divided into two branches or paths, a mechanical transmission branch 110 with a fixed ratio and a hydrostatic transmission branch 120 with a variable ratio, before being recombined at or upstream of the output drive shafts 134, 136. The hydrostatic branch with variable ratio may also be referred to as a variator. In the present case, the transmission 100 is an output coupled planetary transmission (also referred to as an input-side power split or divider planetary power-split transmission) in which the power is split into the mechanical transmission branch 110 and hydrostatic transmission branch 120 by an epicyclic or planetary gear assembly 148 coupled to the input shaft 102. The power is subsequently recombined or summed at a summing shaft 104 upstream of the output drive shafts 134, 136. The summing shaft 104 is drivingly coupled to the front and rear output drive shafts 134, 136 by an intermediary gear 156 rotationally fast with the summing shaft 104 and an offset gear 158 rotationally fast with the front and rear output drive shafts 134, 136 and which is drivingly engaged with the intermediary gear. In other embodiments, the power can be recombined at one or more output drive shafts which functions as a summing shaft.

In other embodiments, the transmission 100 may be an input coupled planetary power-split transmission (also known as a summing planetary power-split transmission) in which a planetary gear assembly is used to recombine the power transmitted through the mechanical and hydrostatic transmission branches.

In the embodiment illustrated, the input shaft 102 may be drivingly coupled to a planetary gear carrier 148a of the planetary gear assembly 148 and the mechanical transmission branch 110 may be driven from the sun gear 148b of the planetary gear assembly 148. As illustrated, the sun gear may be drivingly coupled to the summing shaft 104 by means of a first output drive gear 150 rotationally fast with the sun gear 148b and a second output drive gear 154 rotationally fast with the summing shaft 104.

In the embodiment illustrated, hydrostatic transmission 120 includes a first hydrostatic device 140 which operates as a hydrostatic pump 140 in a forward drive mode of the vehicle 1. The first hydrostatic device may be driven from a ring gear 148c of the planetary gear assembly 148, for example though a pump gear set 152. The first hydrostatic device 140 is hydraulically connected to a second hydrostatic device 142 and a third hydrostatic device 142a, each of which operates as a motor in the forward drive mode. Drive shafts of the first and second hydrostatic devices are drivingly coupled to the summing shaft 104.

In the embodiment shown in FIG. 2, the intermediary and offset gears 156, 158 enable the axes of the front and rear output drive shafts 134, 136 to be offset relative to the hydrostatic motors 142, 142a and enable a gear reduction. However, in other embodiments it may not be necessary to offset the axes of the front and rear output drive shafts 134, 136 and the intermediary and offset gears 156, 158 could be omitted so that the summing shaft 104 forms, or is directly connected with, the front and rear output drive shafts 134, 136. In still further embodiments, a speed range gear box may be incorporated between a summing shaft 104 and any output drive shaft or shafts 134, 136.

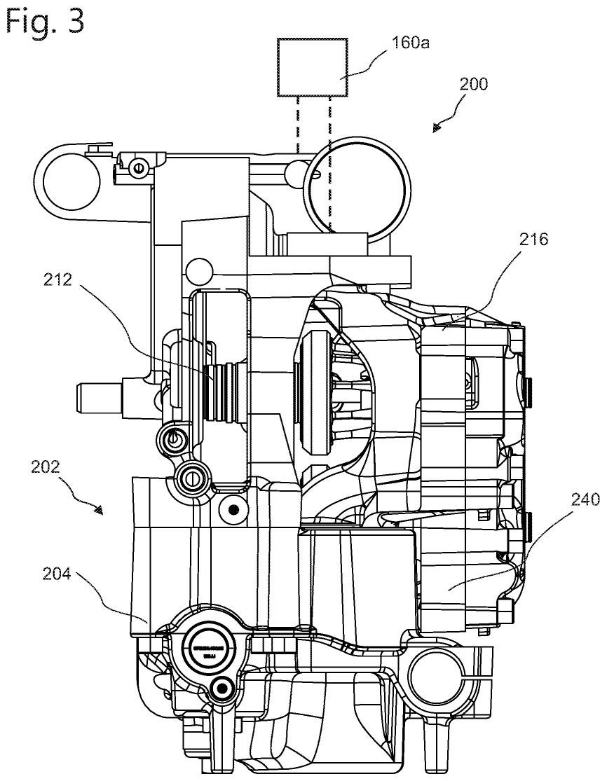

The hydrostatic devices 140, 142, 142a are assembled into a hydrostatic transmission module 200 illustrated in FIGS. 3 to 5. The hydrostatic transmission module has a housing 202 including a lower bridge housing 204 and an upper housing 206.

The hydrostatic devices 140, 142, 142a are each of the bent axis design as is well known in the art. Each hydrostatic device includes a cylinder block defining a number of cylinders circumferentially spaced about an axis of rotation of the cylinder block and fluid ports. A corresponding number of pistons are slidably received in the cylinders. Pivoting the axis of the cylinder block varies the displacement volume of the hydrostatic device. The pistons are drivingly connected with a drive shaft.

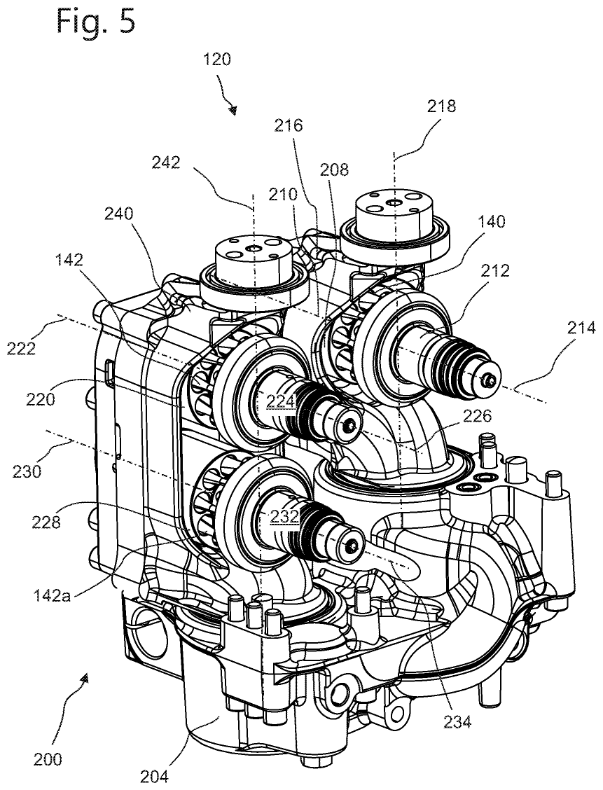

As best seen in FIG. 5, the cylinder block 208 of the first hydrostatic device 140 is rotatable about an axis 210. The first hydrostatic device 140 has a drive shaft 212 which rotates about an input axis 214. The first drive shaft 212 is drivingly coupled to the pump gear set 152. The first hydrostatic device 140 includes a first pivot housing 216 which supports the cylinder block 208. The first pivot housing 216 is mounted to the lower bridge housing 204 and the upper housing 206 for rotation about a first pivot housing axis 218 to pivot the axis 210 of the cylinder block 208 and so adjust the displacement of the first hydrostatic device 140.

The second hydrostatic device 142 is located laterally alongside the first hydrostatic device 140. Its cylinder block 220 is rotatable about an axis 222. The second hydrostatic device has a drive shaft 224 which is rotatable about an axis 226.

The third hydrostatic device 142a is located vertically below the second hydrostatic device 142. Its cylinder block 228 is rotatable about an axis 230. The third hydrostatic device has a drive shaft 232 rotatable about an axis 234. The drive shafts 224, 232 of the second and third hydrostatic devices are drivingly coupled to each other and the summing shaft 104 though a gear train 170, 172, 174. However, any suitable arrangement for coupling the drive from the second and third hydrostatic devices 140, 142 to the summing shaft 104 or any other suitable part of the drive train can be used.

The second and third hydrostatic devices 142, 142a are operated synchronously and share a common, second pivot housing 240. The second pivot housing 240 rotatably supports the cylinder blocks 220, 228 of the second and third hydrostatic devices 142, 142a. The second pivot housing 240 is mounted to the lower bridge housing 204 and the upper housing 206 for rotation about a second pivot housing axis 242 to pivot the axes 222, 230 of the cylinder blocks 220, 228 and so simultaneously adjust the displacement of the second and third hydrostatic devices 142, 142a. The second pivot housing axis 242 is parallel to and laterally spaced from the first pivot housing axis 216. In this case, the first and second pivot housing axes 218, 242 are vertically aligned so that the first and second pivot housings 216, 240 are arranged side-by-side in a lateral direction of the hydrostatic transmission module 200. This has the benefit that the overall height of the module 200 can be kept to a minimum. The first and second pivot housings 216, 240 overlap in the length direction, as measured along their respective axes of rotation 218, 242. The whole length of the first pivot housing 218 is in overlapping relation with the second pivot housing 240. The upper ends of the first and second pivot housings 216, 240 where they are journaled to the upper housing 206 lie in a common plane.

Fluid passages are defined in the lower bridge housing 204 and each of the first and second pivot housings 216, 240 to fluidly connected the cylinder block ports in the first hydrostatic device 140 with those in each of the second and third hydrostatic devices 142, 142a. The fluid passages define a first fluid path and a second fluid path. When operating in a forward drive mode, the first fluid path enables high pressure fluid to be delivered from the first hydrostatic device 140 to an inlet side of each of the second and third hydrostatic devices 142, 142a, whilst the second fluid path enables low pressure fluid to be returned from an output side of each of the second and third hydrostatic devices 142, 142a to the first hydrostatic device 140. The fluid passages defined in the first and second pivot housings 216, 240 are connected with fluid passages defined in the lower bridge housing through rotary joints where the pivot housings are journaled to the lower bridge housing in a known manner.

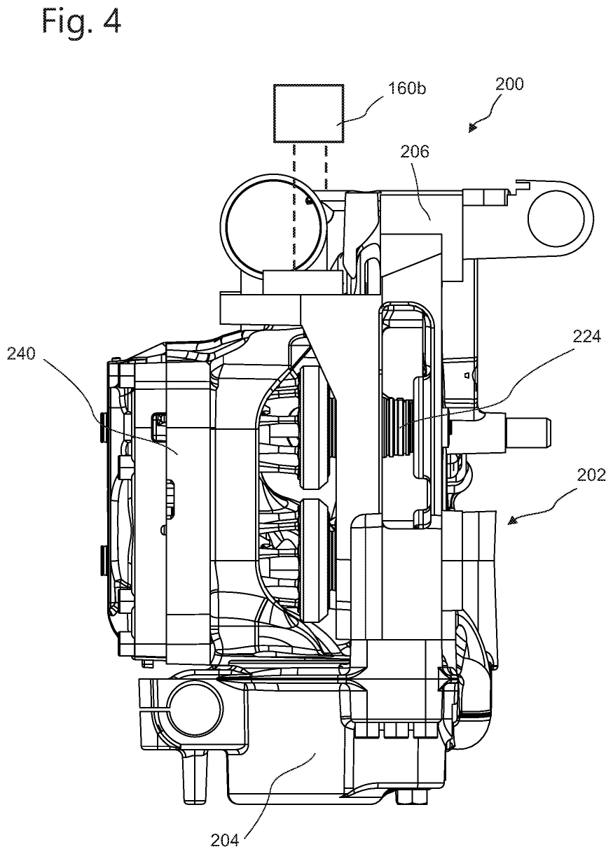

Rotational movement of the first and second pivot housings 216, 240 relative to the housing 202 of the transmission module to adjust the displacements of the first, second and third hydrostatic devices is regulated by a displacement control system 160 operating under the control of the electronic control system 50. The displacement control system includes a first actuator (indicated schematically at 160a in FIG. 3) which is operative to rotate the first pivot housing 216 relative to the transmission housing 202 about its axis of rotation 218. The displacement control system includes a second actuator (indicated schematically at 160b in FIG. 4) which is operative to rotate the second pivot housing 240 relative to the transmission housing 202 about its axis of rotation 242.

The use of two hydrostatic motors 142, 142a is particularly suitable for high horsepower applications. The drive shafts 224, 232 of the second and third hydrostatic devices are drivingly coupled to the summing shaft 104, for example though a gear system 170, 172, 174. The gear system 170, 172, 174 is configured such that the second and third hydrostatic devices operate at different speeds whilst both driving the summing shaft 104. To this end, each of the second and third hydrostatic devices is connected to the summing shaft at a different gear/rotational ratio. The second and third hydrostatic devices 142, 142a may be of similar, or the same, design specification in terms of displacement/flow. The fluid power supplied by first hydrostatic device 140 being split between the second and third hydrostatic devices as a function of their relative speed as determined by the respective gear ratios to the summation shaft 104. The system may be configured so that the second and third hydrostatic devices 142, 142a operate with at a speed difference in the range of 2% to 15%, or more particularly in the range of 5% to 10%, for example. As the frequency of fluid pulsation generated by a hydraulic piston machine is proportional to its rotational speed, operating the second and third hydrostatic devices 142, 142a at different speeds means that the pulsation frequency of the two devices 142, 14a will be different. This is beneficial since the fluid pulsations generated by the second and third hydrostatic devices will not interfere negatively with one another (e.g., the amplitudes of the pulsations will not be increased due to constructive interference). Furthermore, the overall bandwidth of pulsations is broader so that any noise generated by the system which may be heard by the driver is less uncomfortable. It will be appreciated that systems other than gears can be used to couple the output shafts 224, 232 of the second and third hydrostatic devices 142, 142a to the summing shaft 104 with different rotational ratios.

The disclosure is not limited to the embodiments described herein but should be understood as encompassing variations and modifications falling within the scope of the various aspects of the disclosure as defined in the appended claims and other equivalent statements set out above. For example, a hydrostatic transmission in accordance with the disclosure need not be provided as part of a power split CVT with mechanical and hydrostatic branches but could be used as an independent transmission.

All references cited herein are incorporated herein in their entireties. If there is a conflict between definitions herein and in an incorporated reference, the definition herein shall control.

1. A hydrostatic transmission including a first hydrostatic device fluidly coupled with both a second hydrostatic device and a third hydrostatic device, the first hydrostatic device comprising a variable displacement bent axis hydrostatic device having a first pivot housing rotatable about a first pivot housing axis to vary the displacement of the first hydrostatic device, each of the second and the third hydrostatic devices comprising a variable displacement bent axis device, the second and third hydrostatic devices having a combined second pivot housing rotatable about a second pivot housing axis to simultaneously vary the displacements of the second and third hydrostatic devices, wherein the first and second pivot housing axes are aligned parallel to and offset from one another, drive shafts of the second and third hydrostatic devices are drivingly coupled to a common shaft and the second and third hydrostatic devices are constrained to operate at different speeds.

2. The hydrostatic transmission according to claim 1, wherein the second and third hydrostatic devices are constrained to operate at speeds that differ in the range of 2% to 15% or, more particularly, in the range of 5% to 10%.

3. The hydrostatic transmission according to claim 1, wherein the first and second pivot housings are arranged side-by-side.

4. The hydrostatic transmission according to claim 1, wherein the first and second pivot housing axes are each aligned generally vertically.

5. The hydrostatic transmission according to claim 1, wherein the first and second pivot housings are rotatably supported on a housing of a hydrostatic transmission module.

6. The hydrostatic transmission according to claim 5, wherein the hydrostatic transmission module housing comprises a bridge housing supporting the first and second pivot housings at one end, the first and second pivot housings and the bridge housing each define at least one fluid passage, the at least one fluid passage in each of the first and second pivot housings being fluidly connected with the at least one fluid passage in the bridge housing through a respective rotary joint.

7. The hydrostatic transmission according to claim 6, wherein the bridge housing supports the first and second pivot housings from below.

8. The hydrostatic transmission according to claim 5, wherein the hydrostatic transmission module housing comprises an upper housing rotatably supporting upper end regions of first and second pivot housings from above.

9. The hydrostatic transmission according to claim 1, the hydrostatic transmission comprising a first actuator for controlling rotation of the first pivot housing about the first pivot housing axis to vary the displacement of the first hydrostatic device and a second actuator for controlling rotation of the second pivot housing about the second pivot housing axis to vary the displacement of the second and third hydrostatic devices.

10. The hydrostatic transmission according to claim 1, configured such that, in use, the first hydrostatic device operates as a pump and the second and third hydrostatic devices operate as motors when operating in a forward drive mode of operation.

11. A power split CVT having a mechanical branch and a hydrostatic transmission according to claim 1.

12. A utility vehicle having a hydrostatic transmission according to claim 1.

13. The utility vehicle according to claim 12, wherein the hydrostatic transmission is part of a power split CVT including a mechanical branch having a fixed ratio, the hydrostatic transmission forming a hydrostatic branch of the power split CVT having a variable ratio.

14. The utility vehicle according to claim 13, wherein the hydrostatic transmission is configured such that, in use, the first hydrostatic device operates as a pump and the second and third hydrostatic devices operate as motors when operating in a forward drive mode of the vehicle.

15. A power split CVT having a mechanical branch and a hydrostatic transmission, wherein the hydrostatic transmission comprises a first hydrostatic device fluidly coupled with both a second hydrostatic device and a third hydrostatic device, the first hydrostatic device comprising a variable displacement bent axis hydrostatic device having a first pivot housing rotatable about a first pivot housing axis to vary the displacement of the first hydrostatic device, each of the second and the third hydrostatic devices comprising a variable displacement bent axis device, the second and third hydrostatic devices having a combined second pivot housing rotatable about a second pivot housing axis to simultaneously vary the displacements of the second and third hydrostatic devices, wherein the first and second pivot housing axes are aligned parallel to and offset from one another.
